(19) United States
(12) Patent Application Publication
(10) Pub. No.: US 2014/0164099 A1
(43) Pub. Date: Jun. 12, 2014

(54) DEVICE, SYSTEM, AND METHOD OF PROVIDING CUSTOMIZED CONTENT

(71) Applicants: Mark Nati Schlesinger, Raanana (IL); Ben Zion Zadik, Raanana (IL)

(72) Inventors: Mark Nati Schlesinger, Raanana (IL); Ben Zion Zadik, Raanana (IL)

(21) Appl. No.: 14/104,097

(22) Filed: Dec. 12, 2013

Related U.S. Application Data
(60) Provisional application No. 61/736,056, filed on Dec. 12, 2012.

(51) Int. Cl. G06Q 30/02

(52) U.S. Cl. CPC G06Q 30/0277
USPC 705/14.43; 705/14.73; 705/14.45

(57) ABSTRACT

A method and system for providing an advertisement customized to displayed content. The method comprises receiving a request to display at least one advertisement to be displayed along with a web object embedded in a webpage; searching a creative database for a data entry matching the web object designated in the request; selecting, using ad-selection rules, at least one advertisement associated with the matching web object, wherein each of the at least one selected advertisement satisfies at least one of the ad-selection rules; determining a timing, a location, an appearance animation associated with each of the at least one selected advertisement, the timing and the location respectively define when and where each of the at least one selected advertisement is displayed with respect to the web object; and generating a response encapsulating each of at least one selected advertisement and the respective timing, location, and the appearance animation associated therewith.

### CROSS-REFERENCE TO RELATED APPLICATIONS

This application claims the benefit of U.S. provisional application No. 61/736,056 filed on Dec. 12, 2012, the contents of which are herein incorporated by reference for all that they contain.

### TECHNICAL FIELD

The present invention relates generally to online advertising, and more particularly to enhancement of the user's attention to the advertised content.

### BACKGROUND

Websites, including commercial, corporate and personal websites, publish advertisements on their web pages. Such advertisements are typically in a form of banner that may comprise static or rich media content. Banners that include rich media content are displayed as a combination of text, audio, still images, animation, video, and interactivity content for forms.

Video clips embedded in webpages provide another platform for advertising content. Typically, a video banner (or a video advertisement) is played prior to or during the clip that a user wishes to view. On the same webpage displaying a video clip, one or more static banners can be embedded as well. However, in most cases, such banners are not associated with the contents of the video clip, and more particularly, the advertised content in such banners is not updated according to the video clip's content. Generally, a static banner advertisement is a single advertising view presented to a viewer. For example, a static banner advertisement may show a new product associated with its slogan, price, and the like.

However, such advertisements are limiting in that even if they are designed to provide relevant information to the viewer, in most cases, such advertisements do not attract the viewers' interest in interacting with the advertisement. As a prime example, video advertisements are usually skipped by viewers because they are reluctant to view the advertised content in anticipation of the video clips they have already selected for viewing. Furthermore, a definitive number of viewers simply ignore banners displayed outside of the video clip's frame.

In addition, website owners currently rely on menus, hyperlinks, buttons and guides to direct (and convert) the customers towards such actions. This is known as a funnel like process. However, if a visitor is watching a video clip and shows interest in a specific content, there is no immediate connection between the motivation presented by the visitor and the looked-for action. That is, the visitor needs to stop viewing the video clip and start a separate process (“journey”) to perform this action.

Consequently, the effectiveness of such advertisements is limited in the value that they provide to both viewers and advertisers. That is, the viewers can become annoyed with advertisements they deem unnecessary or irrelevant to their interests, or that are displayed at an inconvenient time. For advertisers it can be difficult to determine the effectiveness of the advertising and the viewers' awareness of the advertised content, thus advertisers cannot justify their return on investments for online video advertisements.

One solution for increasing the interaction of users with the displayed video is to provide the content creator or provider with the means to add interactive commentary to the displayed video. The added commentary may be a link to a website of the advertised product, background information about the video, and the like. However, the disadvantage of such a solution is that the commentary is edited and added prior to the publication of the video. As a result, the commentary cannot be modified based on the interaction of viewers with the displayed content.

Further, video annotations cannot be optimized in real time, based on, for example, interaction with the displayed video, predefined templates, and the like. The annotations are typicality static and cannot be programmed, and further, they provide limited presentation possibilities. Lastly, modification of annotation is per video, consequently they cannot be performed for bulk video clips.

It would therefore be advantageous to provide a solution that would overcome the deficiencies of the prior art with regard to online video advertising platforms.

### SUMMARY

Certain embodiments disclosed herein include a method for providing an advertisement customized to displayed content. The method comprises receiving a request to display at least one advertisement to be displayed along with a web object embedded in a webpage; searching a creative database for a data entry matching the web object designated in the request; selecting, using a plurality of ad-selection rules, at least one advertisement associated with the matching web object, wherein each of the at least one selected advertisement satisfies at least one of the plurality of ad-selection rules; determining a timing, a location, and an appearance of animation associated with each of the at least one selected advertisements, wherein the timing and the location respectively define when and where each of the at least one selected advertisement is displayed with respect to the web object; and generating a response encapsulating each of the at least one selected advertisement and the respective timing, location, and the appearance of animation associated therewith.

Certain embodiments disclosed herein also include a server for providing an advertisement customized to displayed content. The server comprises a processor communicatively connected to a network; and a memory coupled to the processor, containing a plurality of instructions that when executed by the processor configures the server to: receive a request to display at least one advertisement to be displayed along with a web object embedded in a webpage; search a creative database for a data entry matching the web object designated in the request; select, using a plurality of ad-selection rules, at least one advertisement associated with the matching web object, wherein each of the at least one selected advertisements satisfies at least one of the plurality of ad-selection rules; determine a timing, a location, and an appearance of animation associated with each of the at least one selected advertisements, wherein the timing and the location respectively define when and where each of the at least one selected advertisement is displayed with respect to the web object; and generate a response encapsulating each of the at least one selected advertisements and the respective timing, location, and the appearance of animation associated therewith.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a network system utilized to describe the various disclosed embodiments.

FIG. 2 illustrates an exemplary data entry in a creative database.

FIG. 3 schematically illustrates the association of a video clip with advertisements and their timings and locations.

FIG. 4 is a flowchart illustrating a method for providing advertisements customized to display content according to one embodiment.

FIGS. 5A, 5B, and 5C are screenshots illustrating the operation of the disclosed method.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

According to various exemplary embodiments, a method is disclosed for displaying advertisements customized to match the content displayed in a web object. The advertisements have an associative connection that can be derived from the content of the web object. The advertisement is displayed at an appropriate time and at a predefined location with respect to the web page object. In an embodiment, the appearance of the advertisement is animated, where different types of animation can be tested and optimized. The advertisement's animation can also be timed, e.g., based on a trigger received from the user device. A web page object, as used herein can be any object, for example, an image, an embedded video, a map, a slide or an embedded presentation or a podcast.

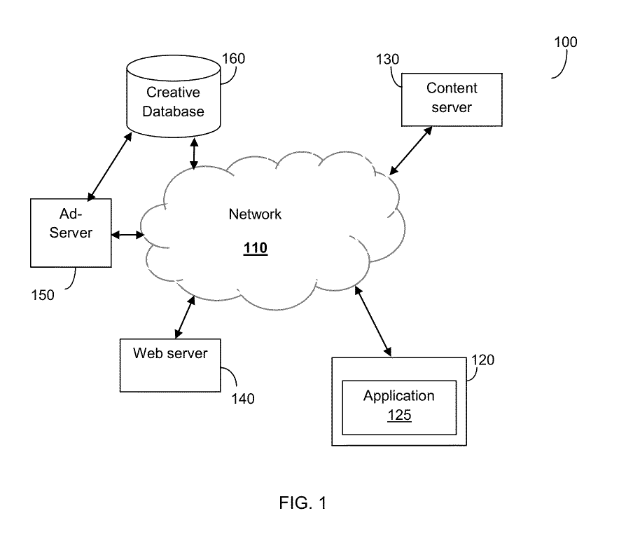

FIG. 1 shows an exemplary and non-limiting schematic diagram of a network system 100 utilized to describe the disclosed embodiments. The system 100 includes a network 110, which may be the Internet, the world-wide-web (WWW), a local area network (LAN), a wide area network (WAN), a metro area network (MAN), and the like.

As illustrated in FIG. 1, at least one user device 120, a content server 130, a web server 140, and an ad-server 150 are communicatively connected to the network 110. The user device 120 may be, but is not limited to, a personal computer (PC), a personal digital assistant (PDA), a mobile phone, a smart phone, a tablet computer, a television, a wearable computing device, a laptop, and the like. The user device 120 is configured to execute at least one application 125 for downloading and displaying webpages. The application 125 can also display and play video clips embedded in web pages. In an exemplary embodiment, the application 125 is a web browser.

The web server 140 hosts one or more websites accessible through the user device 120. The content server 130 stores at least video clips to be embedded in the web pages provided by the web server 140. The content server 130 may be a server of a video sharing website (e.g., YouTube®), and a dedicated content server of a content provider, and the like. In another embodiment, the content server 130 may be a CDN system utilized by video streaming services or websites, such as Netflix®, Hulu®, and the like. It should be noted that one user device 120, one content server 130, and one website are illustrated in FIG. 1 only for the sake of simplicity and without limitation on the generality of the disclosed embodiments.

According to the various embodiments disclosed herein, the ad-server 150 is configured to select, define, assign, and associate advertisements customized to an object viewed by a user of the user device. As will be discussed below, the advertisements are dynamically changed through the play of the video clip and displayed in such a time and location as to draw the most attention from the viewer. As noted above, the appearance of the advertisements can also be animated. The object may include, for example, a file, an image, a video clip, a video file, a map, text, an audio file, a slide, a media file, a multimedia file, a digital media file, a podcast, a presentation, and the like. For the sake of simplicity and without limitation on the generality of the disclosed embodiments, the “web object” will be referred to as a video clip.

The advertisements may be any customized content used, for example, with respect to, and/or to perform the functionality of: a call-to-action, such as a suggestion presented to the viewer that encourages performing a responsive action like buying a related product, reading another article, seeing another video, or subscribing to a newsletter or a magazine; as well as a notice, i.e., a method to bring a piece of information to the viewer's attention. The call-to-action or suggestion provided by the disclosed embodiments allow viewers who show interest in a specific content to take the relevant action, thereby leading viewers to the last step in the funnel. That is, in an embodiment, the advertisements' customized content includes placing the action itself (e.g., form, buy button, etc.) in association with displayed content, in order to shorten the viewer's (customer) response. Therefore, the call-to-action is triggered in the best timing, thereby providing the ability to perform the desired action.

The advertisement may be originated from external parties (such as ad-exchange, advertising network, affiliate-network, etc.) and/or locally, e.g., originated from a website or publisher affiliates that include a webpage object. The customized content of the advertisements may include one or more customized advertisements, e.g., one or more advertisement files, advertisement images, video clips, advertisement video files, text advertisements, advertisement banners, audio advertisements, and the like. The advertisements can also include links (URLs) to landing webpages associated with the advertiser and/or provide additional information about the advertised content. In one embodiment, when the user clicks on the call-to-action included in the advertisement, the landing webpage will be opened and viewable in the video frame. The landing webpage can be opened at any location on the browser or as an over layer frame.

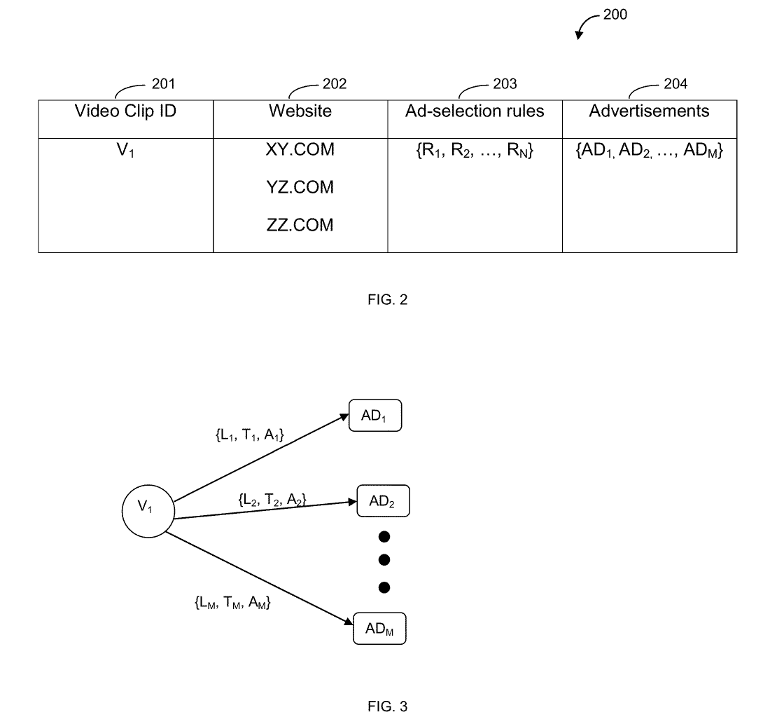

A creative database 160 is communicatively connected to the ad-server 150. The database 160 maintains for each video clip, a designation to display advertisements, such as one or more advertisements to be displayed along with a video clip. Specifically, each video clip is associated with one or more websites and a set of configurable ad-selection rules to provide the database mapped to the one or more advertisements. An exemplary entry in the creative database 160 is provided in FIG. 2.

As illustrated in FIG. 2, a data entry 200 in the creative database 160 lists in a video column 201 a video ‘V₁’, in a website column 202 a list of webpages ‘XY.COM’, ‘YZ.COM’, and ‘ZZ.COM’, a set of ad-selection rules {R₁, R₂, . . . , R_{N}} in column 203, and a list of advertisements {AD₁, AD₂, . . . , AD_{M}} in column 204. The webpages in column 202 designated in the webpages in which the video V₁ is displayed. The ad-server 150 is configured to select one or more advertisements from {AD₁, AD₂, . . . , AD_{M}} that satisfy one more ad-selection rules {R₁, R₂, . . . , R_{N}}. For example, advertisements AD₁ and AD₂ are selected if rule R₁ is satisfied and advertisements AD₁ and AD_{M} are selected when the ad-selection rule R_{N} is satisfied. The ad-selection rules can be ignored or overridden by a management system (not shown) through an API.

The ad-selection rules {R₁, R₂, . . . , R_{N}} can be defined per region, per user, per website, per webpage, per subdirectory, per type of device, time of the day, week days, a current location of a user device, tags, and so on. In one embodiment, the ad-selection rules {R₁, R₂, . . . , R_{N}} can be modified, created or deleted in real-time. This allows the provider to timely change the advertisement's selection responsive to, for example, interaction of viewers with the advertised content. The list of webpages can be designed using, for example, URLs, domain names, and the like. In an embodiment, a default set of advertisements is predefined for a website, when such a website displays a video clip that is not recorded in the database 160.

As noted above, one of the ad-selection rules is a tag which describes the content of the video clip. A tag may include one or more keywords describing the content directly or associatively, a category of content, when the timing the specific content appears, and optionally the location of the content in the video clip. Following is an example of a tag defined for a video clip:

Tag1: For a scene in a video showing a cat.

Keywords: Cat, Pet, Cat Food, Funny Cat,

Category: Pets

Time in Video: 70 seconds

Location: Upper left frame

The tagging of video content can be performed manually or automatically during which the fed video is tagged by users based on the displayed content. The created tags are saved in the creative database in association with their respective video clips. In an embodiment, the output of a tagging process is an HTML embedded code that can be placed in a webpage to display the advertised content. The embedded code is programed to automatically replace the site's original webpage object. An example for providing advertisements based on tags is discussed below.

In an embodiment, the creative database 160 is configured to maintain for each video clip the timing and location to display each advertisement associated with the video clip. As schematically illustrated in FIG. 3, the video V₁ is associated with a set of video clips {AD₁, AD₂, . . . , AD_{M}} that should be respectively displayed at location and timing, with a specific appearance animation {<L₁, T₁, A₁>, <L₂, T₂, A₂>, and <L_{M}, T_{M}, A_{M}>}. In an embodiment, the locations L₁, L₂, and L_{M} may be the same location in the video clip frame, however the times that such video clips are displayed may be different. The appearance animation may be, for example, fade in, diagonal entrance, dissolve, fall and bump, and the like. The advertisements contain no defined animation, thereby the appearance animation is optional. The database 160 also maintains a set of preferences to display the video (V1), such as the player's size, looks, and feel options, resolution and the like. The database 160 also includes a set of client-optimization rules which operate. Such rules are associated with selected advertisements and video and determine which data to gather by the user device 120 and how to modify the advertisements without querying the ad-server 150. As will discuss below, the client-optimization rules allow performing client side optimization.

The timing for displaying the advertisement may be predefined by a user of the ad-server 150 (e.g., a campaign manager, a blogger, a website owner, etc.) by defining, one or more tags. In an embodiment, the timing for displaying the advertisement is event-based. An event that triggers a display of an advertisement is a scene with a potentially high engagement, i.e., a scene in which the viewer is more responsive to the advertisement. Such an event can be determined using a set of heuristics, prediction models, past performance, and/or behavioral patterns of viewers with respect to the advertised content.

As a non-limiting example, a static (or “dead”) scene where there is not much activity for several seconds is considered as having potential for high engagement, because the viewer is typically bored and consciously waiting for stimulation. An advertisement displayed during such a scene can stimulate the user's activity. As another example, during a sports clip, an advertisement would not be displayed during a peak (climax) scene, e.g., scoring a goal or hitting a homerun, as the viewer's attention would not be drawn to the advertised content.

In one embodiment, each advertisement in the creative database 160 is categorized and has matching keywords, which describe the advertisement. The creative database 160 is also configured to maintain past performance data for each advertisement. The performance data may include, for example, how well the advertisement converted (to sales) in the past impressions, mouse hovers, and so on. Such information can be interpreted as the advertisement's potential earning value. The creative database 160 also maintains data analytics discussed in detail below.

Referring back to FIG. 1, according to the disclosed embodiments, when the application 125 requests a web page from the web server 140, a script (e.g., a JavaScript) is added to the requested page. Alternatively, the requested web page may be preprogrammed with the script. The script is adapted to determine if there is a video clip (or any web object as defined above), and sends a unique identification (ID) of the video clip to the ad-server 150. The ad-server 150 can also receive from the user device 120 information including the source of the video clip, a URL of the requested web-page, client identifiers (e.g., user name, IP address, etc.), the device type (e.g., a smartphone, a tablet computer, etc.), and so on.

Using the received information the ad-server 150 is configured to crawl through the database 160 in order to identify at least one entry that matches the clip's unique ID. Then, the at least one advertisement associated with the video clip is selected based on the URL of the requested web-page and satisfaction of at least one ad-selection rule defined with respect to the matching video. As an example, to the data entry 200 demonstrated in FIG. 2, if the matching video clip is V₁, then the selection of advertisements {AD₁, AD₂, . . . , AD_{M}} is based on the ad-selection rules {R₁, R₂, . . . , R_{N}} and if the received URL matches one of the listed webpages ‘XY.COM’, ‘YZ.COM’, and ‘ZZ.COM’.

According to one embodiment, the ad-server 150 is configured to match tags describing the displayed content in a video clip to advertisements in the creative data base. The selected advertisements are sent to the user device 120 to be displayed at the appropriate timing and the predefined location as set for each advertisement. If no matching advertisements were found, then a predefined set of advertisements is used. The default set can be predefined by a user of the system, e.g., a website owner, an advertiser, and the like.

As non-limiting example, the website NBA.COM displays video clips of basketball matches, interviews with players, and other basketball related content. This website also offers sale of NBA related merchandise, such as jerseys and caps. In this example, the video is the “Play of the Day” (http://www.nba.com/video/playoftheday/002201.flv). Two advertisements are selected to add to this clip: one appears as the video begins and the other appears after the “action” of the player has concluded for the video (e.g., 15 seconds after the video clip starts). The first advertisement invites the user to purchase a cap of the player's team and the other advertisement offers a jersey of the player's team.

In one embodiment, the ad-server 150 is configured to collect data about interaction of users with the advertisements. Such data may include the timing in which the advertisements were displayed, impressions, mouse hovers, ad clicks, clicks into commission, and so on. The ad-server 150 is also configured to collect data about interaction of users with the displayed video players playing the video clips, regardless of the interaction with the advertisements. This may include collection of the video player's actions, such as open video, video play, video pause, fast forward, player size changed, last/maximum point in time the video was played, and so on. The ad-server 150 is also configured to collection data about the viewer and the device 120. This may include, for example, demographics, device type, browser type, browsing history, video watching history and so on. The collection is performed through the script running on the user device 120. All the collected data will be referred to as “data analytics”.

The collected data analytics is processed in order to optimize the selection of the advertisement and the action associated with the advertisement. For example, if the analysis of the data analytics determines that the viewers from Europe are more responsive to the jersey's advertisement, then the first advertisement would be removed or replaced with an advertisement for a team's jersey. The optimization of the advertisement selection is performed, in part, by changing the ad-selection rules initially set for the respective video clip and a webpage.

In one embodiment, the analytics data collected with respect to the viewer interaction with the advertisement and the player is processed to provide earning history for each advertisement, i.e., how well an advertisement generated an income for the advertiser. The advertisements can be ranked based on their earning history. The ad-server 150 can utilize the advertisements' ranking to filter out advertisements that underperformed, thereby optimizing the selection and appearance of advertisements. The advertisement selection can be based on the ranking, e.g., by setting a selection rule to select only advertisements with ranking above a predefined threshold, thereby optimizing the selection and appearance of advertisements.

The ad-server 150 typically comprises a processing unit coupled to a memory (both not shown). The memory contains instructions that can be executed by the processing unit. The ad-server 150 also includes a network interface (not shown) to the network 110 and the creative database 160 to submit queries and retrieved data therefrom. In an embodiment, the creative database 160 may be integrated in the ad-server 150. The ad-server 150 may be deployed in a cloud-computing infrastructure.

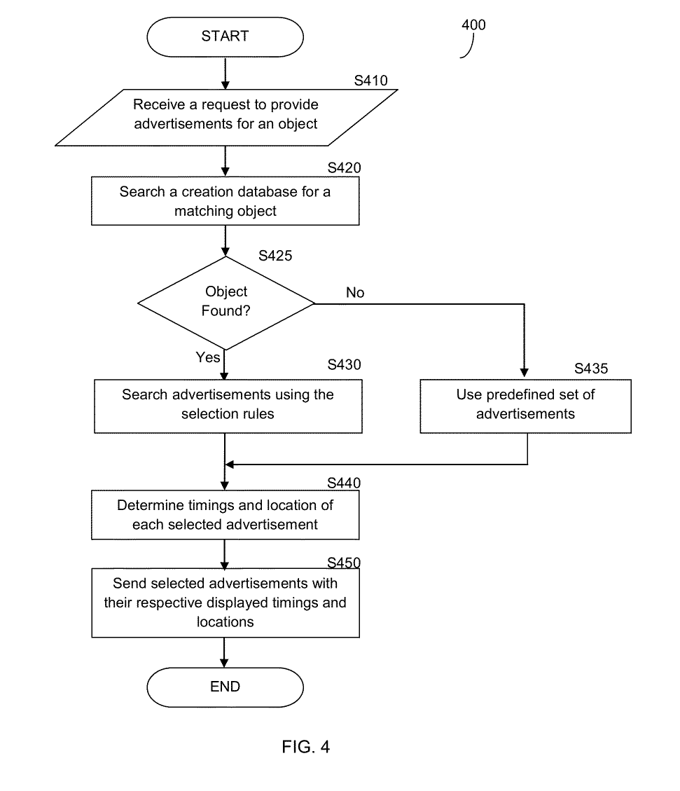

FIG. 4 shows an exemplary and non-limiting flowchart 400 describing a method for providing advertisements customized to the displayed content according to one embodiment. Prior to the execution of the method, the creative database 160 is populated. Specifically, the creative database 160 is created to list a plurality of video clips (or other web objects as defined above). The database 160 further maintains mapping of each video clip to webpages in which such clips can be embedded, one or more ad-selection rules, one or more ad-actions rules, and a list of advertisements advertising products that can be related or associated with the content of the video clip. The database 160 also maintains the timing and location of each advertisement that will be displayed with a respective video clip, and the earning history of the advertisement.

The database 160 is continuously updated with new video clips, collected data analytics, and so on. The viewer's interaction data included in the gathered analytics is saved in the creative database 160 and contains, in part, a number of times the viewer interacted with the web object (e.g., number of times the user played the video); a number of times the viewer viewed a certain advertisement; the number of times that a viewer clicked upon a certain advertisement, and so on. The collected viewer data is filtered to remove non-real users' interactions with the advertisements. The analytics data is associated with the respective advertisement in the creative database 160.

In an embodiment, the video clips and a set of advertisements associated with a video clip can be saved in the database 160 by content publishers, advertising agencies, and the like. The video clips and a set of associated advertisements can also be exported from an external system, such as a real-time engine, a re-targeting engine, static repository, ad-exchange servers, and the like. A content publisher typically has its own products offering, such as a creative database containing advertisements, and/or strategic actions that the publisher or its affiliates would like to expose or direct their audience to. Such a publisher can be, for example an e-commerce site that has content on its web site such as tutorials (video/picture etc.) as well as products for sale. The e-commerce site owner can use this process to present advertisements, coupons or links to a purchase screen on its tutorials, videos, and images.

As another example, content websites, e.g., MTV®, NBA®, Disney®, etc. are interested in displaying an advertisement of a product displayed in the web page object. In addition, the URL associated with the click of this advertisement directs the clicking user to a web page in a store on the Internet where this product is sold or to a coupon or discount for this product. The web page (e.g., the online store) can be opened in the video window player, an over layer frame, or at any location on the web browser.

The ad-selection rules can be initially set by a user (e.g., a campaign manager) of the ad-server 150 and can be later optimized through an optimization cycle disclosed herein. The list of webpages can be automatically populated by crawling to webpages in which the respective video clips appear or are defined by a user of the system.

At S410, a request to provide advertisements associated with a video clip embedded in a web page is received from a user device. As noted above, such a request can be generated by a script running in the web-page. The received request includes at least a unique ID of the embedded video clip. The request may also include information identifying the viewer of the video and/or the user device (e.g., device 120).

At S420, the creative database is searched to find an entry matching the received ID of the embedded video clip. At S425, a check is made if such an entry was found, and if not, execution proceeds to S435 where a predefined set of advertisements is selected. Otherwise, at S430, one or more advertisements is selected based on the configurable ad-selection rules defined for the video and the webpage in which the video clip appears. That is, only a subset of the advertisements that satisfy the one or more ad-selection rules is selected. The ad-selection rules can be defined per region, per client, per website, per type of device, advertisements ranking, time of the day, a tag, and so on. The ad-selection rules can be ignored or overridden in real-time due to instructions from the user device or through a management system communicatively connected with the ad-server 150. The selection can be based on a combination of rules. For example, 10 advertisements would satisfy a region requirement and out of the 10 advertisements, only 3 advertisements with the highest rank are selected by applying a ranking-base rule.

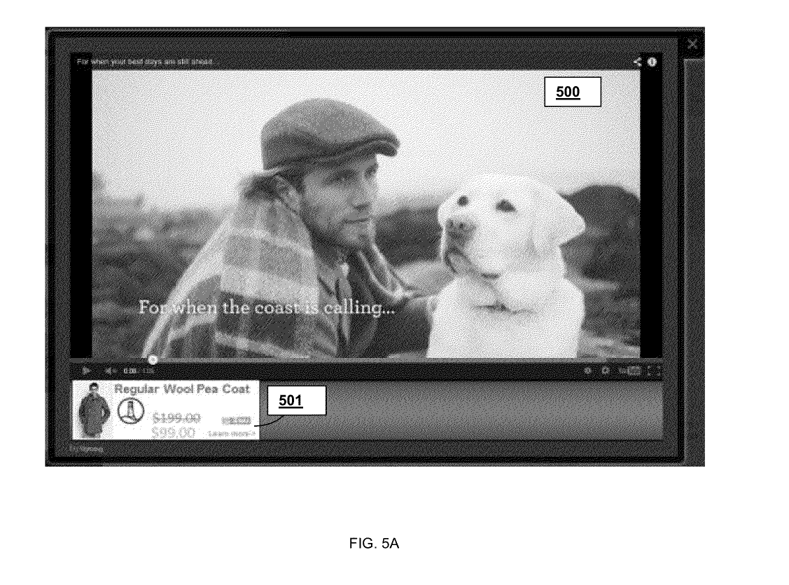

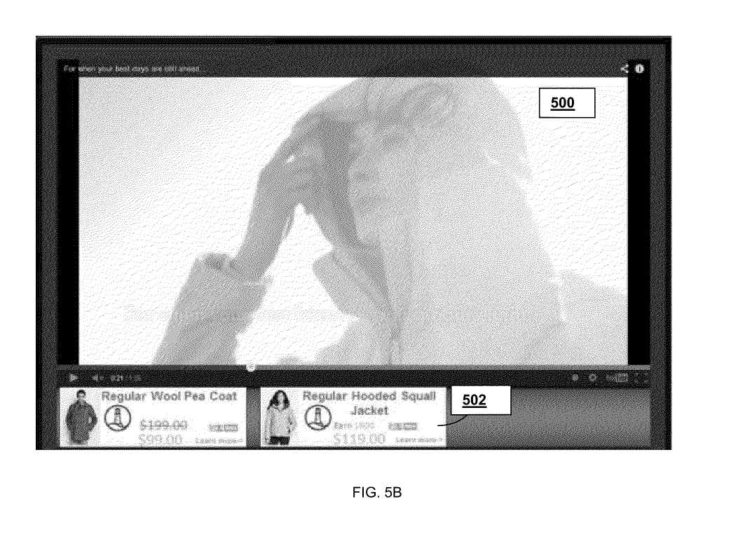

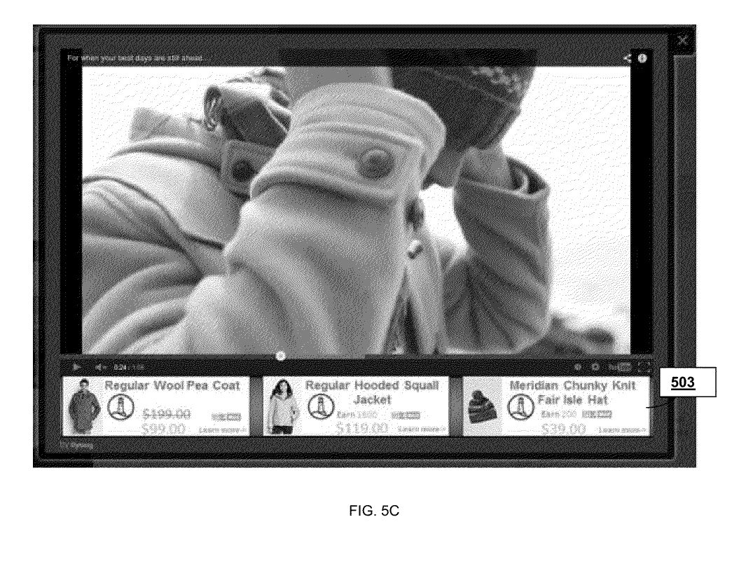

At S440, for each selected advertisement, at least the timing and location to display the advertisement along with the video clip is retrieved. As discussed in detail above, such timing and location are determined in such way that they will increase the viewer interaction with the advertised content. For example, advertisements are displayed during static scenes, but not during “climax scenes”. In an embodiment, the advertisements are placed inside a frame of the video player, preferably below the displayed content. Exemplary screenshots illustrating the placement of the advertisements at the different timings are provided in FIGS. 5A through 5C. In one embodiment, an animation for the appearance of each selected advertisement may be also retrieved. The animation may be fade in, diagonal entrance, dissolve, fall and bump, and the like. In one embodiment, one or more ad-selection rules to be processed on the user device are also retrieved. Such rules are utilized for a client side optimization. For example, dynamically changing the advertisements based on data gathered in real-time. The client side optimization is performed without querying the ad-server 150.

At S450, a response is generated to encapsulate the selected advertisements together with their respective timings, locations, animations, and rules utilized for the client optimization. The response is sent to the user device to be displayed along with the embedded video clip. According to one embodiment, a code, e.g., a HTML code is generated and sent to the user device. The code is added to the webpage (or replaced with the original webpage's code) and causes the display of the advertisements according their specified location and timing.

Referring to FIG. 5, a fashion video clip 500 is displayed over a user device. In FIG. 5A, a first advertisement 501 is displayed, at the left corner of the video frame, 8 seconds after the clip starts. The advertisement 501 is for a wool coat that the model in the video wears. As shown in FIG. 5B, a second advertisement 502 is displayed, at the center of the video frame, 21 seconds after the clip starts. The second advertisement 502 is for a hooded jacket that the female model in the video wears. As presented in FIG. 5C, a third advertisement 503 is displayed, at the right corner of the video frame, 24 seconds after the clip starts. The advertisement 503 is for a hooded jacket that the male model wears. As can be noticed all advertisements 501-503 are displayed at different timings and different locations.

In an exemplary embodiment, if the viewer replays the video, then the same advertisements may be displayed all together at the same time or by using the sequence discussed above. If the user visits the same webpage in which the fashion video clip 500 is embedded, then a new set of advertisements may be displayed to the user as a result of an optimization discussed herein.

It should be noted that the method described herein with reference to a single viewer is merely for the sake of simplicity. However, the selected advertisements will be displayed for all viewers visiting the webpage with the embedded video clip. Therefore, a large dataset of interaction data can be collected. The collected data is utilized to optimize the advertisements selection in order to increase the interaction with the advertisements. The optimization process can be further utilized to optimize the timing in which each advertisement is displayed.

To this end, information including analytic data is constantly gathered from the interaction of the video clips and the advertisements with the viewer. Non-limiting examples for the collected data are provided above. The viewer interaction data is analyzed to optimize the ad-selection rules and to compute the earning history of the advertisement. The earning history is further utilized to update the ranking of the advertisement.

The analysis of the ad-selection rules includes, in part, determination of which of the original rules provided the advertisements that attracted the most users and which of the advertisements are most profitable. The analysis may be performed by using machine learning algorithms. Based on the analytic data and using a target function (known as a fitness function) the optimized selection is found.

The optimization of the advertisements ranking and selection rules can cause selection of new advertisements from the same clip. That is, the optimization cycle runs constantly and changes the selection of the advertisements in real-time. If the same viewer or a different viewer accesses the same web-page in the future, different advertisements may be displayed.

Following is a non-limiting example for the operation of the disclosed method when tags are utilized as the ad-selection rules. A blogger posts a blog about a new smartphone that was released and wishes to include a video clip in the blog. The blogger can tag sections in the video clip for display of advertisements. For example,

Tag 1:

Keywords: iphone, iphone applications

Category: smartphone

Time in video: 8 seconds

Location: center

Tag 2:

Keywords: blind dates, valentine,

Category: dating

Time in video: 41 seconds

Location: center

Tag 3:

Keywords: cars accident, insurance, airbags

Category: cars

Time in video: 47

Location: center

After completing the tagging process, a code (e.g., HTML code) is generated and can be embedded in the blog site. Behind the scenes, the tags are sent to the creative database. The creative database contains advertisements where each advertisement has a defined category and keywords describing it. For each of the keywords defined in a tag and according to the tag category, matching advertisements are searched. In this example, Tag1 returned 40 advertisements, Tag2 returned 6 advertisements, and Tag3 returned 20 advertisements. The advertisements of each tag are ranked according to the number of matching keywords and past earning history of the advertisement (if it exists). The top 5 advertisements of each tag are saved in the database. Each tag receives a unique ID and the unique ID of the user which added the tags. The rank of each advertisement is also saved. In an embodiment, a bidding process for specific tags can be performed. The bids are submitted through a bidding platform communicatively connected to the ad-server 150.

When a viewer accesses the blog, the ad-selection rules determine how many and which advertisements to display. For instance, the selection may be based on the ranking of the advertisements and/or tags. Information is gathered about the displayed advertisements and the interaction of viewers with the advertisement.

As noted above, the disclosed embodiments are also applicable to other web objects, such as but not limited to images, maps, online presentations, podcasts, and the like. In an embodiment, an advertisement for an image is matched to a content displayed in the image. The advertisement is displayed on the webpage of the viewer when the viewer first views the image. Then, when the viewer opens the page or scrolls the image into view or sometime after first occurrence of the image, the advertisement is displayed. The advertisement can also be displayed when the image is clicked upon for a larger view of the image.

In another embodiment, an advertisement is matched to a location on the map. The advertisement is displayed when the viewer opens the map in the matched location. In yet another embodiment, an advertisement is matched to a content displayed in a slide part of an online presentation. The advertisement can be displayed when the slide is opened or at a predefined time after it is opened. In yet another embodiment, the advertisement is matched to a content which is in context to the current feed from the podcast. The advertisement can be displayed anywhere on the webpage.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing an advertisement customized to displayed content, comprising:
receiving a request to display at least one advertisement to be displayed along with a web object embedded in a webpage;
searching a creative database for a data entry matching the web object designated in the request;
selecting, using a plurality of ad-selection rules, at least one advertisement associated with the matching web object, wherein each of the at least one selected advertisements satisfies at least one of the plurality of ad-selection rules;
determining a timing, a location, and an appearance of animation associated with each of the at least one selected advertisements, wherein the timing and the location respectively define when and where each of the at least one selected advertisements is displayed with respect to the web object; and
generating a response encapsulating each of the at least one selected advertisements and the respective timing, location, and the appearance of animation associated therewith.

2. The method of claim 1, wherein the web object is at least a video clip.

3. The method of claim 2, wherein the request is received from a user device and the generated response is sent to the user device.

4. The method of claim 3, wherein the generated response causes the display of the at least one selected advertisement and its associated timing, location, and the appearance of animation.

5. The method of claim 4, wherein the location for displaying the at least one selected advertisement is under a frame of the web object.

6. The method of claim 3, wherein the timing for displaying the at least one selected advertisement creates an association between the advertised content and the content displayed by the web object.

7. The method of claim 3, wherein the timing for displaying the at least one selected advertisement is during a static scene.

8. The method of claim 1, wherein selecting of the at least one advertisement is performed based on the webpage in which the web object is embedded.

9. The method of claim 1, wherein each of the ad-selection rules is defined for any one of: a region, a webpage, a website, a client, a type of a user device, a time of the day, weekdays, a current location of a user device, and a tag.

10. The method of claim 1, further comprising:
collecting data analytics with respect to interaction of viewers with the at least one selected advertisement and the web object; and
analyzing the collected data analytics; and
optimizing the selection of the at least one selected advertisement based on the analysis of the collected data analytics.

11. The method of claim 10, wherein analyzing the collected interaction further comprises: computing earning history for the at least one selected advertisement.

12. The method of claim 11, wherein optimizing the selection of the at least one selected advertisement further comprising:
modifying at least one of: the plurality of ad-selection rules initially used for the selection and the timing and the location associated with the at least one selected advertisement.

13. The method of claim 11, wherein optimizing the selection of the at least one selected advertisement is performed in real-time, thereby increasing the probability of user views of the at least one selected advertisement.

14. The method of claim 11, further comprising:
selecting at least one client-optimization rule; and
encapsulating at least one client-optimization rule in the generated response, wherein the at least one client-optimization rule allows real-time optimization of the selection and display of the selected advertisements on the user device.

15. The method of claim 1, wherein the at least one advertisement provides a call-to-action functionality.

16. A non-transitory computer readable medium having stored thereon instructions for causing one or more processing units to execute the method according to claim 1.

17. A server for providing an advertisement customized to displayed content, comprising:
a processor communicatively connected to a network; and,
a memory coupled to the processor, containing a plurality of instructions that when executed by the processor configure the server to:
receive a request to display at least one advertisement to be displayed along with a web object embedded in a webpage;
search a creative database for a data entry matching the web object designated in the request;
select, using a plurality of ad-selection rules, at least one advertisement associated with the matching web object, wherein each of the at least one selected advertisements satisfies at least one of the plurality of ad-selection rules;
determine a timing, a location, and an appearance of animation associated with each of the at least one selected advertisements, wherein the timing and the location respectively define when and where each of the at least one selected advertisements is displayed with respect to the web object; and
generate a response encapsulating each of the at least one selected advertisements and the respective timing, location, and the appearance of animation associated therewith.

18. The server of claim 17, wherein the system is further configured to:
collect data analytics with respect to interaction of viewers with the at least one selected advertisement and the web object;
analyze the collected data analytics; and
optimize the selection of the at least one selected advertisement based on the analysis of the collected data analytics.

19. The server of claim 18, wherein the system is further configured to:
modify at least one of: the plurality of ad-selection rules initially used for the selection and the timing and the location associated the at least one selected advertisement.

20. The server of claim 19, wherein optimizing the selection of the at least one selected advertisement is performed in real-time, thereby increasing the probability of user views of the at least one selected advertisement.

21. The server of claim 18, wherein the system is further configured to:
select at least one client-optimization rule; and
encapsulate at least one client-optimization rule in the generated response, wherein the at least one client-optimization rule allows real-time optimization of the selection and display of the selected advertisements on the user device.

22. The server of claim 17, wherein the at least one advertisement provides a call-to-action functionality.
